(19) United States
(12) Patent Application Publication
(10) Pub. No.: US 2005/0184525 A1
(43) Pub. Date: Aug. 25, 2005

(54) Starter control apparatus

(75) Inventor: Motoi Hisamoto, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 10/782,864

(22) Filed: Feb. 23, 2004

(51) Int. Cl. B60L 11/02; F02N 11/08

(52) U.S. Cl. 290/30 R

(57) ABSTRACT

There is provided a starter control apparatus including a control circuit board which can reduce the number of parts and prevents erroneous fitting. An earth pattern is formed in the vicinity of an attachment hole of the control circuit board and only on a one surface, positions of attachment holes of the control circuit board provided in a case and a cap are made different from each other between a case where an earth system is body earth and a case where it is earth float, and the respective positions are made symmetrical positions with respect to the attachment position center line of the control circuit board, so that fitting is enabled only when the control circuit board is put face-up in the case of the body earth type and only when it is put face-down in the case of the earth float type.

### BACKGROUND OF THE INVENTION

1. Field of the Invention

The present invention relates to a starter control device for controlling a starter to start an engine and a starter having the control device, particularly to a structure in which a control circuit part is provided on a cap of an auxiliary switch.

2. Description of the Related Art

A conventional device of this type is disclosed in Japanese Patent Laid-Open No. 2000-87831, for example. In a starter protector device thus disclosed, a protector circuit is disposed in a space defined by legs of a mounting bracket of an auxiliary switch. The protector circuit and a terminal provided on a cap of the auxiliary switch are connected to each other by a lead wire.

In the starter protector device thus structured, since the protector circuit and the terminal provided on the cap of the auxiliary switch are connected to each other by the lead wire, a work to remove the insulating cover from the lead wire and a work to apply preliminary soldering to a conductive part of the lead wire are required. Also, a vibration proof performance is degraded. Further, to integrally form the auxiliary switch and the protector circuit, it is necessary metal attachment for electrically connecting the control circuit part and the terminal.

With such a structure, the present invention provides the starter control device and the starter improved in that the electrical connection is easy, the device size is small, the integration of the auxiliary switch with the control circuit part is easy, and the cost to manufacture is low.

### BRIEF DESCRIPTION OF THE DRAWINGS

FIG. 1 is a perspective view showing a starter control device which is a first embodiment of the present invention;

FIG. 2 is a cross sectional view showing a main portion of the starter control device of the first embodiment;

FIG. 3 is an electric wiring diagram in the first embodiment;

FIG. 4 is a circuit diagram showing a control circuit part in the first embodiment;

FIGS. 5(a) to 5(f) are timing charts showing an operation of the first embodiment;

FIG. 6 is a perspective view showing a starter control device which is a second embodiment of the present invention; and

FIGS. 7(a) and 7(b) are a front view and a side view showing a starter having the starter control device of the second embodiment.

and electrically connected to the cap 4 by use of a washer 10. A connection part 9b as one end of the connection metal attachment 9 is bent toward the housing 5, which contains the control circuit part 3, and connected to the control circuit part 3. Similarly, the B terminal 7 and a seat 11a of a connection metal attachment 11 are mechanically and firmly fixed and electrically connected to the cap 4 by use of a washer 12. A connection part 11b as one end of the connection metal attachment 11 is bent toward the housing 5, which contains the control circuit part 3, and connected to the control circuit part 3.

The auxiliary switch 2 includes a coil 14, which is housed in a case 13 formed of a conductive member such as an iron plate. One end of the coil 14 is connected to the SW terminal 8 provided on the cap 4. The C terminal 6 and the B terminal 7 are electrically connected to and disconnected from each other depending on current fed to the coil 14. A mounting bracket 15 formed of a conductive member such as an iron plate is fastened to the cylindrical outer peripheral surface of the case 13 by welding or the like. The mounting bracket 15 includes a leg part 15a having a mounting hole 15b.

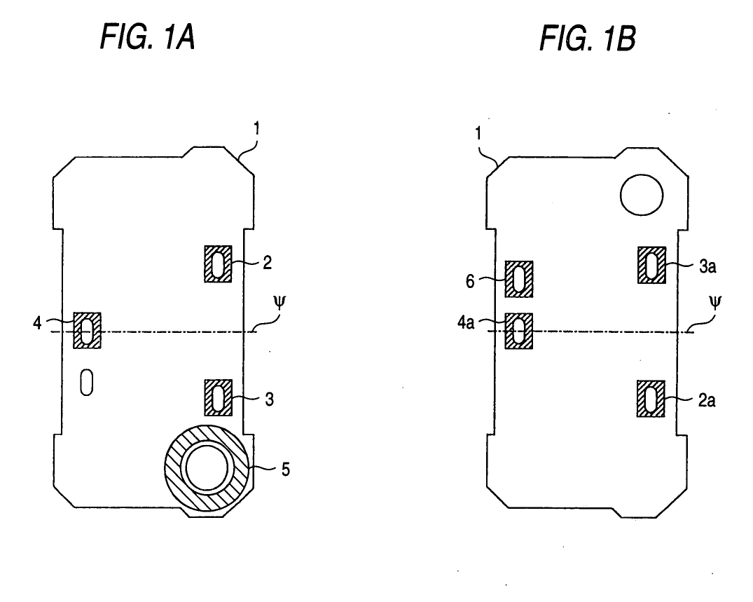

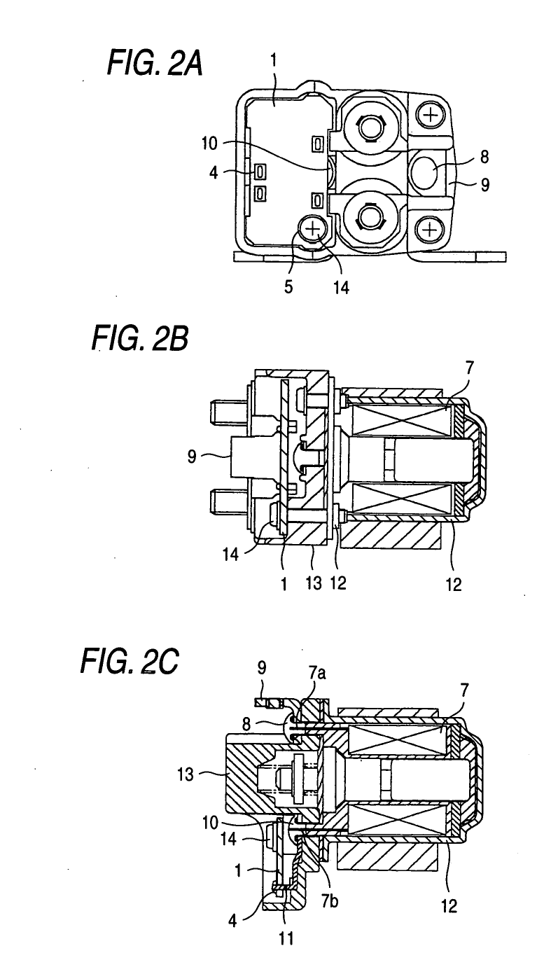

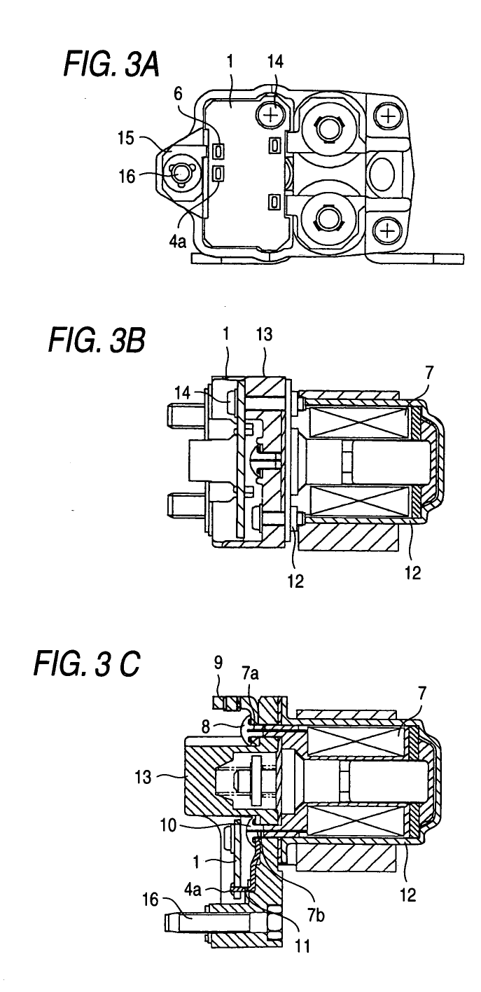

FIG. 2 is a cross sectional view showing a main portion of FIG. 1. As seen in FIG. 2, the control circuit part 3 is contained in the housing 5 that is integrally formed with the cap 4. The C terminal 6 is electrically connected by soldering or the like to a substrate 16 of the control circuit part 3 2 and the control circuit part 3. The auxiliary switch 2 includes the C terminal 6, B terminal 7 and a movable contact 33, which constitute electric contacts, and the coil 14 for controlling the opening and/or closing of those electric contacts.

A plus side of the battery 20 is connected to the battery terminal 30 of the starter 19 through a battery cable 34, and a minus side of the battery 20 is earthed. The plus side of the battery 20 is connected to the SW terminal 8 of the starter control device 1 by way of a starter terminal 21b of a key switch 21. Reference numeral 21a designates an ON terminal 21a of the key switch 21 and is used during engine running. The starter terminal 21b is made contact at the time of engine starting operation. The plus side of the battery 20 is connected to the B terminal 7 of the starter control device 1. The C terminal 6 is connected to the S terminal 27 of the main switch 23. The internal connection of the starter control device 1 is as described above.

In FIG. 4 showing a circuit diagram of the control circuit part 3, Q1 and Q2 are transistors; Q3 is an FET; IC1 and IC2 are comparators; D1 to D4 are diodes; ZD1 and ZD2 are Zener diodes; R1 to R12 are resistors; and C1 is a capacitor. Those circuit components are connected as shown in FIG. 4. Voltage is constantly applied from the battery 20 to a point B in FIG. 4, by way of the B terminal 7 and the connection metal attachment 11. Voltage is applied from the battery 20 also to the gate S terminal 27 of the main switch 23 by way of the C terminal 6. The P coil 28 and the H coil 29 are fed with a current, and the movable contact 32 is moved to close a circuit between the battery terminal 30 and the motor terminal 31. When the movable contact 32 is closed, a current flows from the battery 20 into the motor unit 22 by way of a route of the battery cable 34, battery terminal 30, movable contact 32, and motor terminal 31. The armature 24 is rotated through the electromagnetic action between the field coil 26 and the armature 24, and a rotational force causes the engine to start. When the engine starts, and the key switch 21 is returned from the starter terminal 21b to the ON terminal 21a, the current flowing to the coil 14 of the auxiliary switch 2 is shut off. The movable contact 33 is closed and the movable contact 32 is opened, so that the current flowing to the motor unit 22 is stopped, and here the engine starting operation is completed.

The operation of the control circuit part 3 will be described with reference to FIG. 4. As described above, the FET Q3 is in an on state. When the starter terminal 21b of the key switch 21 is closed, a current is fed from the battery 20 to the coil 14 by way of the SW terminal 8. The movable contact 33 is moved to close the circuit between the B terminal 7 and the C terminal 6, so that voltage of the battery 20 appears at the C terminal 6. The voltage is led from the C terminal 6 to a point C in FIG. 4 by way of the connection metal attachment disappears. When the voltage disappears at the C terminal 6, the capacitor C1 having been charged to the voltage determined by the Zener diode ZD2 and the diode D1 discharges at a time constant defined by the resistor 10 and the capacitor C1. With the discharging operation, the voltage at the minus terminals of the comparators IC1 and IC2 gradually decreases. Thus, a timer circuit is constituted, in which the capacitor C1 is discharged at the time constant defined by the resistor 10 and the capacitor C1.

The voltage produced by dividing the voltage as determined by the Zener diode ZD2 and the diode D1 by the resistors R7 and R8 is applied to the plus terminal of the comparator IC1. This voltage is lower than that at the minus terminal of the comparator IC1, and then a logic state at the output of the comparator IC is L, and the FET Q3 is turned off. Accordingly, the capacitor C1 discharges and gradually decreases to be lower than that at the plus terminal of the comparator IC1. The off state of the FET Q3 continues till the logic state at the output of the comparator IC1 is H. During this period, even if the key switch 21 is turned to the starter terminal 21b, no current is fed to the coil 14 since the FET Q3 is in the off state, and the starter 19 does not operate.

FIGS. 5(a) to 5(f) are timing charts showing those sequential operations. In FIG. 5(a), reference numeral 1 is voltage at the plus terminal of the comparator IC1; 2 is a vary as shown in FIG. 5(a). A logic state at the output terminal of the comparator IC2 varies from H to L. The output terminal of the comparator IC1 continues a high logic state. When the starter terminal 21b of the key switch 21 is turned off, the FET Q3 is turned off and the movable contact 33 of the auxiliary switch 2 is also turned off. Accordingly, the starter 19 operates in connection with the starting operation of the key switch 21. Accordingly, the power source of the substrate 16 of the control circuit part 3 continues the on state.

Then, during a time period from time T1 to T2, the starter terminal 21b is placed to an off state, and the starter terminal 21b is placed to an on state again at time T2. At this time, the voltage at the minus terminal of the comparator IC1 has been higher than that at the plus terminal of the comparator IC1. Therefore, the output terminal of the comparator IC1 is L in logic level, and the FET Q3 is in the off state, the movable contact 33 of the auxiliary switch 2 is also turned off, and the starter 19 does not operate. This time continues till the voltage at the minus terminal of the comparator IC1 becomes lower than that at the plus terminal of the comparator IC1, and at time T3, the FET Q3 is turned on. This time is time T in FIG. 5 and corresponds to a re-operation preventing time of the starter 19. Thereafter, at time T4, the voltage at the minus terminal of the comparator IC2 becomes lower than that at the plus terminal of the comparator IC2. As a result, The electrical connection is easy, the countermeasure to noise is ensured, the device size reduction is easy, excellent vibration proof is ensured, the physical integration of the auxiliary switch 2 with the control circuit part 3 is easy, and cost to manufacture is low. The starter control device 1 of the invention is easily applied to a starter system not having the control device. In this way, a starter 19 having such advantageous functions may easily be constructed. In this respect, the standardization of the starter 19 is ensured. Further, a resistance of the coil 14 of the auxiliary switch 2 is higher than that of the P coil 28 and the H coil 29 of the main switch 23. This enables a reduction in a required current and a reduction in size of the FET Q3 and the key switch 21.

An additional feature of the invention is that the C terminal 6 is connected to the control circuit part 3 by the connection metal attachment 9. With this feature, if the voltage at the C terminal 6 is detected, one can know that the starter terminal 21b of the key switch 21 is start-operated. Therefore, a wiring becomes unnecessary and the integration of the control circuit part with the auxiliary switch 2 is easy. A further feature is to detect the generated voltage of the starter 19. Therefore, there is prevented such an unwanted situation that the starter 19 operates during the inertia rotation of the armature 24, thereby damaging the starter 19 and parts of the engine side. circuit part 3 is controlled. This feature brings about the following advantages. Even in a case where the power source to the control circuit part 3 is fed from the B terminal 7, the power source is automatically turned off after a predetermined time, and little power consumption is made, the life of the battery 20 is elongated, and advantageous contribution to noise reduction is effected.

### Second Embodiment

A second embodiment of the invention will be described. FIG. 6 is a perspective view showing a starter control device which is a second embodiment of the invention. A structure of the starter control device of the embodiment is substantially the same as of the first embodiment. In the figure, like reference numerals are used for designating like or equivalent portions in FIG. 1. FIG. 7(a) is a front view showing a control-device contained starter in which the starter control device is incorporated into the starter. FIG. 7(b) is a side view of the starter when seen in a direction of X. In the figure, a control-device contained starter 19a is generally made up of a mechanism part 35, motor unit 22, main switch 23 and starter control device 1. A bracket 36 forming an outer shell of the mechanism part 35 is formed with a conductive member such as an aluminum die casting member. The motor unit 22, main switch 23 and starter control device 1 are integrally mounted on the bracket 36. Aleg part 15a of the starter control The normal starter 19 not having the control circuit part 3 but having the auxiliary switch 2 may easily be altered into a control-device contained starter 19a by merely physically incorporating the starter control device 1 instead. In this respect, the standardization of the starter 19 is realized. The starter 19 not having the auxiliary switch 2 may also be altered into a control-device contained starter without additionally applying wiring to the engine side. Further, the starter 19 is formed integrally with the starter control device 1. This results in good mountability. When the control-device contained starter 19a is used, a system with the control circuit can be constructed without any additional wiring in a self-completing manner.

As seen from the foregoing description, a starter control device comprises an auxiliary switch for controlling an operation of a starter main switch, the auxiliary switch having a cap made from an insulating member; a control circuit part disposed on the cap; a terminal disposed on the cap; and a connection metal attachment for connecting the control circuit part and the terminal. With such a structure, the present invention succeeds in providing the starter control device improved in that the wire connection is easy, the device size is small, the physical integration of the auxiliary switch with the control circuit part is easy, and the cost to manufacture is low.

Further, in another aspect of the invention, a C terminal prohibits the starter from performing a re-operation for a predetermined period of time, and controls an on time of the power source to the control circuit part. This unique feature provides a starter control device which is easily constructed, has high performances, and consumes less electric power.

The present invention provides a control-device contained starter in which the starter control device is incorporated into a starter. Therefore, a system which is easy in its constructing and has good mountability can be produced in a self-completing manner.

1. A starter control apparatus, comprising:
a conductive case for housing an exciting coil;
a cap made of an insulating member and attached to close an open end of the case; and
a control circuit board on which a control circuit is mounted and which, together with the cap, is attached to the case through the cap and is fixed by a conductive attachment screw,
wherein an earth pattern is formed in a vicinity of an attachment hole of a one surface of the control circuit board, and
an earth system of the apparatus is properly used for both types of body earth and earth float by changing an attachment direction.

2. A starter control apparatus according to claim 1, wherein when the earth system is the body earth, the attachment direction is set so that the earth pattern provided in the vicinity of the attachment hole is positioned at a head side of the attachment screw.

3. A starter control apparatus according to claim 1, wherein when the earth system is the earth float, the attachment direction is set so that the earth pattern provided in the vicinity of the attachment hole is positioned at a side of the cap.

4. A starter control apparatus according to claim 3, wherein an earth connection pattern is provided on the other surface of the control circuit board and at a portion other than the vicinity of the attachment hole, and when the earth system is the earth float, an earth terminal is led out via the earth connection pattern.

5. A starter control apparatus according to claim 1, wherein an attachment screw hole for the control circuit board and an attachment hole provided in the case and the cap are provided at different positions between a case where the earth system is the body earth and a case where the earth system is the earth float, and the respective positions are symmetrical positions with respect to an attachment position center line of the control circuit board.

6. A starter control apparatus according to claim 2, wherein an attachment screw hole for the control circuit board and an attachment hole provided in the case and the cap are provided at different positions between a case where the earth system is the body earth and a case where the earth system is the earth float, and the respective positions are symmetrical positions with respect to an attachment position center line of the control circuit board.

7. A starter control apparatus according to claim 3, wherein an attachment screw hole for the control circuit board and an attachment hole provided in the case and the cap are provided at different positions between a case where the earth system is the body earth and a case where the earth system is the earth float, and the respective positions are symmetrical positions with respect to an attachment position center line of the control circuit board.

8. A starter control apparatus according to claim 4, wherein an attachment screw hole for the control circuit board and an attachment hole provided in the case and the cap are provided at different positions between a case where the earth system is the body earth and a case where the earth system is the earth float, and the respective positions are symmetrical positions with respect to an attachment position center line of the control circuit board.
